(19) United States
(12) Patent Application Publication
(10) Pub. No.: US 2003/0037569 A1
(43) Pub. Date: Feb. 27, 2003

(54) Method and apparatus for forming patterned and/or textured glass and glass articles formed thereby

(76) Inventors: Mehran Arbab, Allison Park, PA (US); James M. Baldauff, Coraopolis, PA (US); Dennis G. Smith, Butler, PA (US); Gerald DiGiampaolo, Allison Park, PA (US)

Correspondence Address: PPG INDUSTRIES INC, INTELLECTUAL PROPERTY DEPT, ONE PPG PLACE, PITTSBURGH, PA, 15272, US

(21) Appl. No.: 10/101,242

(22) Filed: Mar. 19, 2002

Related U.S. Application Data
(60) Provisional application No. 60/277,317, filed on Mar. 20, 2001.

(51) Int. Cl. C03B 18/14

(52) U.S. Cl. 65/22; 65/51; 65/93; 65/99.2; 65/146

(57) ABSTRACT

The present invention provides a method of producing patterned and/or textured glass by applying a material onto at least a portion of a glass substrate, e.g., a float glass ribbon, at or above a softening point of the material and/or the glass substrate. The material is configured to affect the surface of the glass substrate to scatter light rays. An apparatus of the invention for forming patterned glass in a float glass process includes an applicator extensible into and out of a float bath chamber above a molten metal bath. A glass article of the invention includes a first surface and a second surface spaced from the first surface. The second surface includes a patterned portion configured to scatter light rays.

### CROSS-REFERENCE TO RELATED APPLICATION

This application claims the benefits of U.S. Provisional Application No. 60/277,317 filed Mar. 20, 2001, which is herein incorporated by reference in its entirety.

### BACKGROUND OF THE INVENTION

1. Field of the Invention

This invention relates generally to forming patterned and/or textured glass articles and, more particularly, to a method and apparatus for forming patterned and/or textured flat glass, e.g., float glass, and to the glass articles made therefrom.

2. Technical Considerations

Flat glass can be produced in a variety of ways, such as roll forming, vertical draw methods, or float methods. For example, in a conventional float process, glass batch materials are heated in a furnace to form a glass melt. The glass melt is poured onto a bath of molten metal in a float chamber where the glass melt is shaped, formed and controllably cooled to form a float glass ribbon. The float glass ribbon can be controllably cooled and/or cut into pieces or sheets outside of the float chamber to form flat glass sheets. The float process typically produces glass sheets with smooth, fire polished top and bottom surfaces. In a vertical draw method, a portion of a glass melt is drawn upwardly from a pool of molten glass and is cooled to form glass sheets.

Ornamental or patterned glass has typically been produced by guiding heat softened flat glass sheets between two rollers, with one roller having an embossed pattern that is pressed into a surface of the softened glass sheet. This conventional rolling technique has drawbacks. For example, the pattern formed on the glass surface is limited to the pattern on the embossed roller. This pattern cannot be easily changed without removing and replacing the embossed roller. Further, the viscosity of the glass must be below a certain threshold value to permit pressing the pattern into the glass, which necessitates a minimum temperature requirement or a minimum viscosity of the glass at the rollers. Moreover, providing a separate embossing line for the exclusive production of rolled patterned glass can be difficult to justify economically in view of the relatively small market for patterned glass. Additionally, during the rolling process the back surface of the glass sheet, i.e., the side opposite to the embossed roller, also becomes rough due to physical contact with the non-embossed roller. This roughened back surface is generally not desirable for an exposed surface, such as the outer surface of an insulating glass unit, because the roughened surface can be difficult to clean and/or aesthetically undesirable.

As an alternative to this conventional off-line embossed roller technique, various attempts have been made to impose patterns or to otherwise modify the surface of a glass ribbon during a float process. For example, U.S. Pat. No. 4,746,347 discloses a method of forming patterned glass by contacting the upper surface of a float glass ribbon with an embossed roller located in the float chamber. U.S. Pat. No. 3,472,641 discloses a process for producing ornamental glass by blowing gas onto the top surface of a float glass ribbon to displace portions of the glass surface to form a desired pattern and then cooling the ribbon to incorporate the pattern into the glass surface. U.S. Pat. No. 3,951,633 discloses a method of texturing the surface of a float glass ribbon by depositing particulate carbon onto the ribbon surface and then combusting the carbon. Other methods of forming patterned glass during a float process are disclosed in U.S. Pat. Nos. 3,749,563; 3,850,605; 3,558,294; 3,672,859; and 4,074,994.

While generally acceptable, these methods of producing ornamental or patterned glass have some of the disadvantages of the previously known roller techniques. For example, utilizing mechanical applicators, such as rollers, still limits the pattern formed on the float glass ribbon to the repeating pattern of the mechanical applicator. Further, the non-mechanical methods employing gas ejectors or materials that attack the glass surface could interfere with subsequent heat treatment of the glass, such as annealing or tempering, or may contaminate the controlled atmosphere of the float chamber, requiring that such gases or materials be utilized in a limited quantity.

Therefore, it would be advantageous to provide a method and/or apparatus which could be used to form patterned and/or textured flat glass, e.g., obscured glass in a float process, that reduces or eliminates at least some of the drawbacks of presently known glass forming methods.

### SUMMARY OF THE INVENTION

The present invention provides a method of producing patterned and/or textured glass by applying a material onto at least a portion of a glass substrate, e.g., onto a surface of a float glass ribbon in a float chamber. At least a portion, e.g., the majority, e.g., all, of the applied material can be incorporated into the substrate, e.g., a float glass ribbon. For example, the material can be incorporated by chemical bonding (such as by covalent or ionic bonding with the glass forming the float glass ribbon), by adhesion with the float glass ribbon, or by physical bonding or entrapment into the float glass ribbon, to form a roughened pattern to provide a light scattering surface on the float glass ribbon to provide a translucent or opaque glass article.

In one particular embodiment of forming a glass article in accordance with the invention, a float glass ribbon in a float chamber is at some point at a temperature above the softening point and/or the glass transition temperature and solid material, e.g., glass particles, are applied onto the surface of the ribbon to incorporate at least a portion of the applied glass particles into the ribbon to provide the ribbon with a light scattering surface.

The present invention also relates to an apparatus for forming patterned and/or textured glass, e.g., in a float process. In one embodiment, the apparatus includes an applicator configured to deposit material onto a float glass ribbon in a float chamber. For example, the applicator can be permanently mounted in the float chamber or can be extensible into and out of the float chamber above the glass ribbon supported on the pool of molten metal to deposit the material onto the top of the float glass ribbon to form patterned and/or textured glass. The applicator can be inactivated or withdrawn to form non-patterned float glass.

Further, the invention relates to a glass article having a light scattering surface and a smooth second surface, e.g., an opposite surface. In one embodiment, the transmittance of electromagnetic energy, e.g., visible light, through the article differs depending upon whether the light is directed toward the light scattering surface or the smooth surface.

### BRIEF DESCRIPTION OF THE DRAWINGS

FIG. 1 is a plan view (not to scale) of a float chamber (with the roof removed for ease of discussion) incorporating features of the invention;

FIG. 2 is a view (not to scale) taken along the line II-II in FIG. 1;

FIG. 3 is a view (not to scale) taken along the line III-III in FIG. 1;

FIG. 4 is a section (not to scale) taken along the line IV-IV in FIG. 1 with the cooling jacket and heat shield removed for ease of discussion;

FIG. 5 is a schematic view (not to scale) of an alternative applicator of the invention;

FIG. 6 is a plan view (not to scale) of another alternative applicator of the invention;

FIG. 7 is a side view (not to scale) of a glass article made in accordance with the invention;

FIG. 8 is an enlarged side view (not to scale) of a portion of the glass article of FIG. 7; and

FIG. 9 is a graph of percent transmittance (at 550 nm) for a glass article made in accordance with the invention.

### DESCRIPTION OF THE INVENTION

As used herein, spatial or directional terms, such as “left”, “right”, “inner”, “outer”, “top”, “bottom”, “above”, “below”, “up”, “down”, and the like, relate to the invention as it is shown in the drawing figures. However, it is to be understood that the invention may assume various alternative orientations and, accordingly, such terms are not to be considered as limiting. Further, as used herein, all numbers expressing dimensions, physical characteristics, quantities of ingredients, reaction conditions, and the like used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. As used herein, the terms “textured glass” or “obscured glass” mean glass having deformations or surface irregularities that result in optical distortions such that an object viewed through the glass appears indistinct, i.e., not sharply outlined or separable, e.g., blurred. The term “patterned glass” means glass having a decorative surface resembling the surface of a glass sheet embossed using a conventional embossed roller process. The term “obscurity of the glass” refers to how distinctly an object can be viewed through the glass, e.g., as the obscurity of the glass increases, an object will appear less distinct and less sharply outlined when viewed through the glass. Further, as used herein, the terms “deposited over” or “provided over” mean deposited or provided on but not necessarily in surface contact with. For example, a coating or material “deposited over” a substrate does not preclude the presence of one or more other coating films or materials of the same or different composition located between the deposited coating or material and the substrate. As used herein, the terms “solar control” or “solar control material” refer to a material that affects the solar performance properties of the glass, e.g., transmittance and/or reflectance of electromagnetic radiation, such as in the visible, ultraviolet (UV), or infrared (IR) regions of the electromagnetic spectrum.

The structural components of a first exemplary apparatus for forming patterned and/or textured glass in accordance with the invention will first be described and then exemplary methods of using the apparatus to form patterned and/or textured glass in a float process will be described. However, it is to be understood that the specifically disclosed exemplary apparatus and methods are presented simply to explain the general concepts of the invention and that the invention is not limited to these exemplary embodiments. Moreover, the invention is not limited to use with the float process but could be practiced in a wide variety of processes, such as but not limited to vertical draw processes. Additionally, the invention can be practiced by depositing material onto a heated substrate whether or not the substrate is part of a flat glass process.

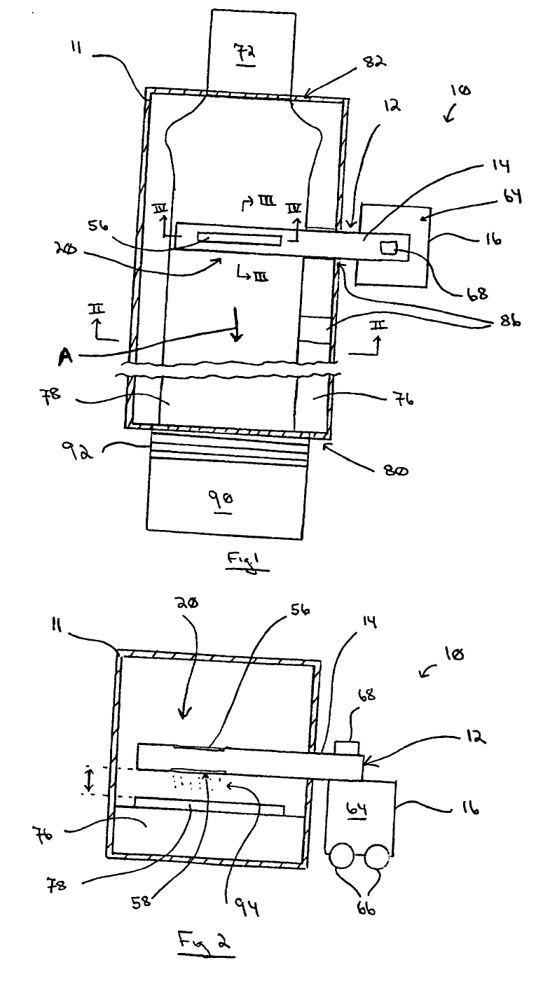

As shown in FIGS. 1-4 and as described below, a first exemplary apparatus 10 of the invention for forming patterned and/or textured glass, e.g., as the glass moves through a float chamber 11, includes an applicator 12. The exemplary applicator 12 shown in FIGS. 1-4 includes an elongated discharge arm 14 mounted on a movable support 16. With reference to FIGS. 1-3 as needed, the arm 14 includes a discharge portion 20 configured to discharge material from the arm 14 onto at least a portion of the surface of a glass substrate, which in this exemplary embodiment is a float glass ribbon supported on a molten metal bath 76 in the float chamber 11. The arm 14 and discharge portion 20 can be of any desired dimensions.

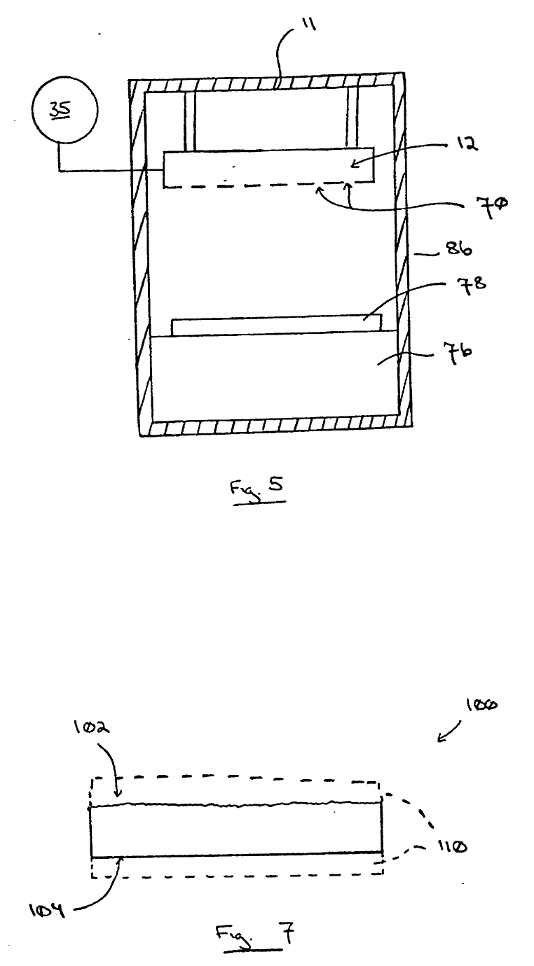

As will be described in more detail below, in one embodiment the applicator 12 is configured to contain and/or direct material through the discharge portion 20 and onto a top surface of a float glass ribbon in the float chamber 11. In the exemplary embodiment shown in FIGS. 3 and 4, the arm 14 is formed from a first member, e.g., a substantially cylindrical, hollow first or inner tube 22, movably or rotatably mounted in a second member, e.g., a substantially cylindrical, hollow second or outer tube 24. The inner and outer tubes 22, 24 can have concentric centers and can be made of heat resistant material, such as metal, e.g., stainless steel. As shown in FIG. 4, the inner tube 22 can have an end cap 26 with a plug 28 spaced from the end cap 26 to define a hollow chamber 30 within the inner tube 22. The inner tube 22 can include at least one opening, e.g., a slot 34, in flow communication with the chamber 30. As will be appreciated, additional plugs 28 can be spaced apart in the inner tube 22 to form additional chambers 30, with each additional chamber 30 in flow communication with a separate slot 34. In the same manner, each chamber 30 could contain the same or a different material to be selectively deposited onto the float glass ribbon.

With reference to FIGS. 3 and 4 as needed, the outer tube 24 can also have an end cap 36 to seal the outer end of the outer tube 24. The outer tube 24 can have at least one charging opening or slot 38 and at least one discharge opening or slot 40, with the discharge slot(s) 40 spaced from the charging slot(s) 38. For example, the discharge slot(s) 40 can be positioned substantially opposite to the charging slot(s) 38. The slots 38, 40 can be continuous, elongated slots or can be formed by a plurality of spaced openings or holes.

In another embodiment (not shown), the inner tube 22 can be formed without the plug 28, i.e., the hollow inner tube 22 can be in flow communication with a source of material to be added to the glass surface and/or a carrier fluid, e.g., a carrier gas, to supply the material to the inner tube 22 in a continuous manner. Alternatively, the material can be supplied to the inner tube 22 using a conventional conveyor device, such as a screw conveyor or auger.

With reference to FIG. 3, an optional cooling jacket 44 can be mounted around the outer tube 24. The cooling jacket 44 can be formed by a double-walled sleeve having a flow channel 46 defined between two walls 48 and 50. The flow channel 46 can be in flow communication with a cooling system having a source of cooling media (not shown), such as water or another liquid or gaseous cooling fluid. One or more baffles or walls (not shown) can be located in the flow channel 46 to direct the cooling media through the flow channel 46. For example, the cooling media can flow outwardly, i.e., toward the discharge portion 20, along the bottom portion of the cooling jacket 44 and then be directed back to the cooling system along the top portion of the cooling jacket 44.

An optional insulation jacket or heat shield 54 can be located around the cooling jacket 44. If present, the heat shield 54 and cooling jacket 44 can each have an opening or slot in flow communication with, e.g., aligned with, the charging slot 38 in the outer tube 24 to form a charging passage 56 extending through the heat shield 54, cooling jacket 44, and outer tube 24. The heat shield 54 and cooling jacket 44 also can have an opening or slot in flow communication with, e.g., aligned with, the discharge slot 40 of the outer tube 24 to form a discharge passage 58.

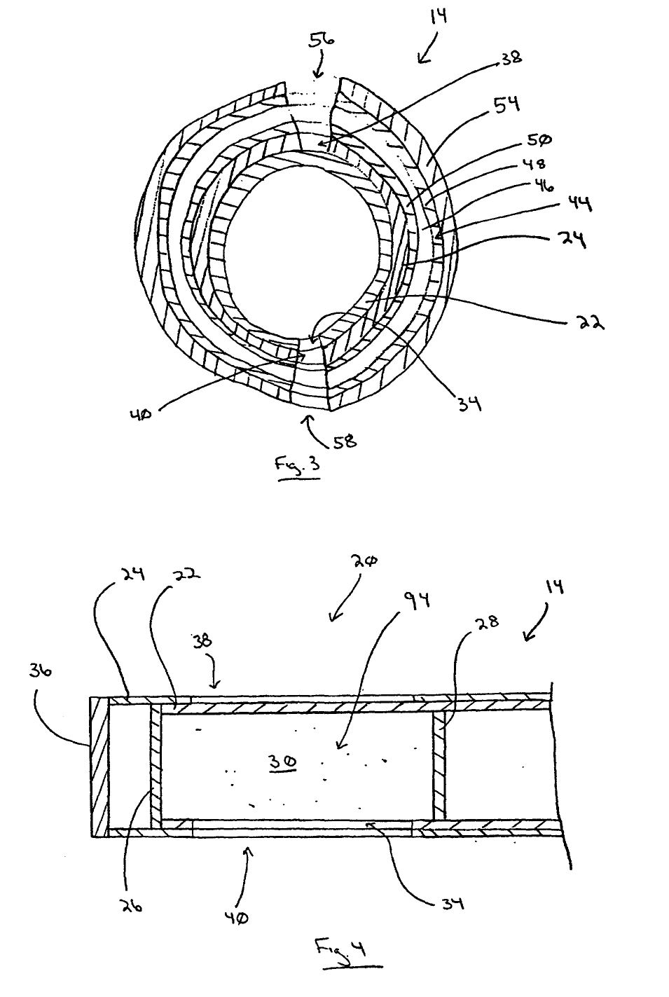

As shown in FIG. 2, the discharge arm 14 can be mounted on, e.g., carried on, the movable support 16. The support 16 can be any structure capable of holding and/or moving the applicator 12. For example, the support 16 can be a slidable shelf, a hydraulically movable piston/cylinder assembly, or a tracked or wheeled vehicle, just to name a few suitable examples. In the exemplary embodiment shown in FIG. 2 but not limiting to the invention, the support 16 is a cart 64 having a plurality of rotatable wheels 66. A vibration device 68, such as a pneumatic or hydraulic vibrator, can be connected to the arm 14, e.g., on a portion of the arm 14 resting on the cart 64.

In an alternative embodiment shown in FIG. 5, the applicator 12 can be non-movably or permanently mounted in the float chamber 11, e.g., mounted to the roof of the float chamber 11. The applicator 12 can be in flow communication with a source 35 of material to be added to the glass surface and/or a carrier fluid, e.g., a carrier gas. The carrier gas can be, for example, 1 volume percent to 5 volume percent of hydrogen gas in nitrogen gas. Alternatively, the source 35 of material can be in flow communication with the applicator 12 by a conveyor, such as a conventional screw conveyor or auger. The applicator 12 can be similar to that described above in which an inner tube 22 is rotatable in an outer tube 24 by any conventional manner, such as a mechanical or electromechanical device connected to the inner tube 22 and extending into the float chamber 11. Alternatively, in the embodiment shown in FIG. 5, the applicator 12 can be formed by a single hollow manifold having one or more discharge slots 70 configured to deposit, e.g., spray, material onto the top of the float glass ribbon in the float chamber 11.

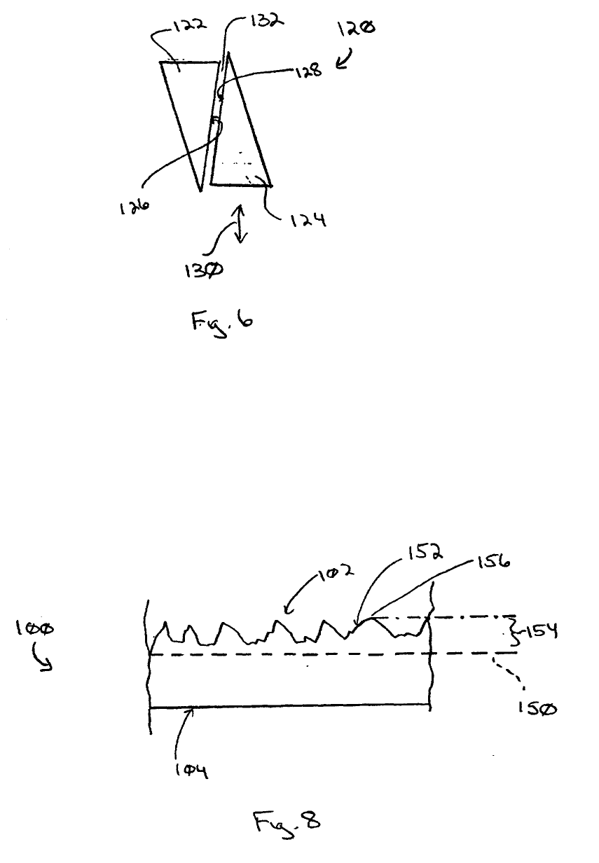

Another exemplary applicator 120 is partially shown in FIG. 6. In this embodiment, the applicator 120 includes a plurality, e.g., two, shaped members 122 and 124. In the embodiment shown in FIG. 6, the members 122 and 124 are triangular in shape, with the respective inner sides 126 and 128 of the members 122 and 124 being parallel or substantially parallel to each other. One of the members 122 can be stationary and the other member 124 can be movable, e.g., as shown by arrow 130, up and down (e.g., towards and away) relative to the member 122. Alternatively, both of the members 122, 124 can be movable. In either case, one or both of the members 122, 124 can be connected to a movement device (not shown), such as a rod, to move or slide one or more of the members 122, 124 to adjust the size of the slot 132 to adjust the flow of material through the slot 132. As will be appreciated from FIG. 6, as the member 124 is moved downwardly (e.g., away from the member 122), the gap or slot 132 between the two members 122, 124 will widen and when the member 124 is moved upwardly (e.g., toward the member 122) the slot 132 will narrow or close. Thus, the members 122, 124 can be in communication with a source of material to be added onto a substrate, e.g., the members 122, 124 can be located on an arm or hollow tube (not shown) below the material source, such that the amount of material discharged can be controlled closely by widening and narrowing or closing the slot 132 by moving the member 124 towards and away from the member 122. The members 122, 124 can be movably carried on an arm (such as a hollow arm) having a source of material.

Having described the structural components of several exemplary applicators 12 which could be used to practice the invention, an exemplary method of producing textured and/or patterned glass in a float process will now be described with particular reference to utilizing one or more applicators 12 shown in FIGS. 1-4. However, it is to be understood that the invention is not limited to use with these particular types of applicators.

In the broad practice of the invention, the substrate utilized to practice the invention can be of any type and can be of any composition having any optical properties, e.g., any value of visible transmission, ultraviolet transmission, infrared transmission, and/or total solar energy transmission. For example, the substrate can be transparent to visible light. By “transparent” is meant having a transmittance through the substrate of greater than 0% up to 100%. By “visible light” is meant electromagnetic energy in the range of 395 nm to 800 nm. Alternatively, the substrate can be translucent or opaque. By “translucent” is meant allowing electromagnetic energy (e.g., visible light) to pass through but diffusing it such that objects on the other side are not clearly visible. By “opaque” is meant having a visible light transmittance of 0%. Suitable materials for the substrate include plastic (e.g., polymethylmethacrylate, polycarbonate, polyurethane, polyethyleneterephthalate (PET), or copolymers of any monomers for preparing these, or mixtures thereof), ceramic, or glass. The glass can be of any type, such as conventional float glass or flat glass, and can be of any composition having any optical properties, e.g., any value of visible transmission, ultraviolet transmission, infrared transmission, and/or total solar energy transmission. Although the present invention can be practiced with any type of glass, such as borosilicate glass, the invention is particularly well suited for flat glass compositions, such as soda-lime-silica glass compositions. A basic soda-lime-silica glass batch composition can include silica (sand), soda ash (a carbonate of soda), dolomite (a carbonate of calcium and magnesium), limestone (a carbonate of calcium), oxidizing agents such as nitrate or sulfate, and reducing agents such as coal. As will be appreciated by one skilled in the art, the relative amounts of the components depend upon the desired composition and performance characteristics of the glass to be made. Additionally, cullet may be added to the glass components either before feeding the components into a melter or during melting. The cullet can be clear glass or can be glass including conventional coloring agents.

Additional materials can also be added to the glass which affect the final properties of the glass, e.g., solar properties such as infrared (IR), ultraviolet (UV), and/or visible transmittance or reflectance, or other optical properties, physical properties, and/or aesthetic properties. Such materials can include elements or compounds of titanium, selenium, cobalt, cerium, vanadium, molybdenum, chromium, nickel, manganese or copper, just to name a few. Generally, in the absence of strong oxidation/reduction reactions, as the amounts of the colorants increase, the visible, IR and UV transmittance of the resultant glass can decrease dependent upon the colorant. Small amounts of other materials can also be present, for example, melting and refining aids, glass modifiers or formers, and tramp materials or impurities, such as elements or compounds of sodium, potassium, calcium, magnesium, manganese, aluminum, sulfur, strontium, zirconium, chlorine, cobalt, nickel, selenium, chromium, molybdenum, barium, titanium, cerium, tin, zinc or iron. Exemplary glass compositions are disclosed in, but are not limited to, U.S. Pat. Nos. 5,071,796; 5,837,629; 5,688,727; 5,545,596; 5,780,372; 5,352,640; and 5,807,417, just to name a few.

As shown schematically in FIGS. 1 and 2, the glass components can be heated in a furnace 72 to form a glass melt. The glass melt can be homogenized, fined, and thereafter discharged onto a pool of molten metal 76, such as tin or a tin alloy, in the float chamber 11. As the glass melt enters the float chamber 11, the molten glass is supported on the molten metal 76 as it moves through the float chamber 11 and is formed into a float glass ribbon 78. The width of the ribbon 78 can be controlled in any conventional manner. For example, for glass thickness less than equilibrium thickness, sets of rotating rolls (not shown) can stretch the ribbon 78 laterally as the rollers outside the float chamber 11 pull the ribbon 78 along the top of the molten metal 76. The molten glass typically can have a temperature in the range of 1900° F.-2200° F. (1037° C.-1203° C.) at the entrance end 82 of the float chamber 11 and a temperature of 1000° F.-1200° F. (537° C.-648° C.) at the exit end 80 of the float chamber 11. In one embodiment of the invention, the float chamber 11 has a reducing atmosphere of nitrogen with less than or equal to 10 volume percent hydrogen and with less than 500 ppm oxygen, such as less than or equal to 200 ppm, e.g., less than or equal to 100 ppm, e.g., less than or equal to 50 ppm.

Conventional float chambers 11 are typically formed by a refractory floor, a roof, and walls, and are generally divided into a plurality of sections or bays, typically of differing temperature. One or more closable access ports 86 can be located in the walls of the float chamber 11 in each bay.

Upon exiting the float chamber 11, the glass ribbon 78 can be moved into an annealing lehr 90, e.g., by a conveyor 92, for controlled cooling or heat treatment, such as annealing. The glass ribbon 78 can be cut into sheets, which can be optionally tempered. The structure and operation of a conventional float process, including the float chamber 11 and annealing lehr 90, will be well understood by one of ordinary skill in the art. Examples of conventional float processes are disclosed, but not to be considered as limiting to the invention, in U.S. Pat. Nos. 4,354,866; 4,466,562; and 4,671,155.

An exemplary method of the invention can be practiced as follows. With the embodiment of the applicator 12 shown in FIGS. 1-4, material 94 to be deposited onto the top of the float glass ribbon 78 is introduced into the storage chamber 30 (FIG. 4) of the arm 14 with the arm 14 positioned outside of the float chamber 11. To introduce the material 94, the inner tube 22 can be rotated clockwise or counter-clockwise until the slot 34 of the inner tube aligns with the charging passage 56 in the top of the arm 14 formed by the slots in the heat shield 54, cooling jacket 44, and the outer tube charging slot 38. The material 94 is then poured into the storage chamber 30 through the charging passage 56. When a desired quantity of material 94 is present in the chamber 30, the inner tube 22 is again rotated clockwise or counter-clockwise until the slot 34 in the inner tube 22 is between the charging slot 38 and the discharge slot 40 of the outer tube 24 such that the opening 34 is closed or sealed by the inner wall of the outer tube 24 to maintain the material 94 in the storage chamber 30.

The material 94 used in the practice of the invention can be any material which provides the resultant glass article with the desired aesthetic and/or light transmitting and/or light scattering characteristics. The material 94 can be of any type, such as but not limited to a solid, a liquid, a vapor, a solid suspended in a liquid or vapor, a semi-solid, or a gel, just to name a few. For example, the material 94 can include crushed or powdered particles of any desired size. In one example, but not limiting to the invention, the particles can be in the range of 26 micrometers to 8 millimeters (mm). The material 94 can be of the same or different composition as the substrate, e.g., crushed glass having the same composition as the float glass ribbon 78 or can be crushed glass of a different composition, such as borosilicate glass, glass ceramic, etc. By way of illustration, the float glass ribbon 78 can be a clear glass composition while the material 94 can be a colored glass composition, i.e., powdered or crushed glass having one or more colorant or solar control materials, such as elements or compounds, e.g., metals or metal oxides, of Ti, Se, Co, Cr, Ni, Mn, Ce, V, Mo, Cu, or Fe. Alternatively, the material 94 can be a mixture of two or more different materials, e.g., clear (i.e., non-colored) glass and colored glass particles or powders; borosilicate glass particles and clear glass particles; crushed glass particles and a metal, e.g., a metal oxide or metal (such as those listed above); or two or more metal oxides; just to name a few. Generally, as the amount of colorant and/or solar control material increases, the visible, infrared, and ultraviolet transmission of the resultant article decreases. Therefore, as colorant or solar control materials are added onto the glass ribbon 78, care must be taken to maintain a desired visible light transmittance and/or desired color of the resultant glass article. Additionally, the material 94 can contain colored ceramic flakes or particles. Moreover, the material 94 can comprise one or more metals or metal oxides, such as those described above.

The material 94 can be a material that can be incorporated into the underlying substrate. By “incorporated into” is meant interacts with, e.g., chemically bonds with (e.g., covalently or ionically bonds with), or is mechanically entrapped in, or fuses with (i.e., adheres to) the glass of the float glass ribbon 78. Additionally, if the resultant glass is to be heat treated, e.g., tempered or annealed, the material 94 can have a thermal expansion coefficient that is the same or substantially the same as that of the glass forming the float glass ribbon 78. By the phrase “substantially the same as that of the float glass ribbon” is meant that the thermal expansion coefficient of the material 94 is such that the resultant article can be heat treated, e.g., tempered or annealed, without breaking or cracking. The choice of material 94 (and hence its thermal expansion coefficient) should allow for adequate stress relief, e.g., during subsequent annealing, or impart a desired stress, such as a compressive stress, to the surface of the ribbon 78 while not irreversibly impacting the ability of the article to be cut.

With the material 94 in place in the storage chamber 30, a port 86 in a side wall of the float chamber 11 can be opened and the discharge arm 14 inserted therethrough. The cooling source can be activated to supply cooling media through the flow channel 46 of the optional cooling jacket 44 to cool the material 94 in the storage chamber 30 to prevent or help reduce the material 94 from undergoing adverse thermal effects, such as melting. The cooling media also helps prevent sagging of the discharge arm 14 due to thermal softening of the material of the arm 14. As can be appreciated by those skilled in the art, the cooling media can remove heat from the ribbon 76 near the discharge arm 14. Additionally, the vibrator 68 can be activated to cause the arm 14 to vibrate to facilitate flow of the material 94 out of the arm 14. Moreover, a carrier gas can be placed in flow communication with the chamber 30 to move material out of the arm 14.

Depending upon where the discharge arm 14 is inserted into the float chamber 11, i.e., the distance of the discharge arm 14 from the entrance end 82 of the float chamber 11 (i.e., the end where molten glass is discharged into the chamber), the general characteristics of the resultant glass article can be affected. For example, with all other deposition parameters remaining the same, in most situations the closer the discharge arm 14 is positioned to the entrance end 82 of the float chamber 11 (i.e., the hotter the ribbon 76), the smoother the upper surface and less light scattering or light deflecting the resultant glass article can be. Exceptions to the above generalization may include instances when, for example, a third phase or compound is formed between the deposited particle(s) and the glass substrate at higher temperatures (and more reaction time) near the front end of the float chamber 11 while the same is prohibited at lower temperatures (and less reaction time) near the exit end of the float chamber 11. Alternatively, the closer the discharge arm 14 is inserted to the exit end 80 of the float chamber 11 (i.e., the cooler the ribbon 76), the rougher the upper surface and more light scattering the glass article can be. With all other parameters remaining the same, the more light scattering the glass surface, the more obscure an object will appear when viewed through the glass, i.e., the more blurred or less sharply outlined the object will appear. Also, the density or mass coverage of the material 94 on the ribbon 78, i.e. the amount of the material 94 applied per unit area of the glass ribbon 78, can affect the optical characteristics of the resultant glass article. For example, with all other deposition parameters remaining the same, as the mass coverage of the material deposited onto the glass ribbon 78 increases, the more light scattering the resultant glass article can be and vice versa. The speed of movement of the glass ribbon 78 under the arm 14 also can affect the characteristics of the resultant glass article. With all other deposition parameters remaining the same, the faster the ribbon speed the less light scattering the resultant glass article can be and vice versa.

The arm 14 can be positioned any distance above the ribbon 78. However, the distance should not be so great as to adversely impact upon deposition of the material 94 onto the ribbon 78. For example, the arm 14 can be positioned less than 5 feet (152 cm) above the top surface of the float glass ribbon 78, such as less than 3 feet (91 cm), e.g., less than 1 foot (30 cm), e.g., less than 6 inches (15 cm), e.g., 1 inch (2.54 cm) to 6 inches (15 cm). To deposit the material 94 on top of the float glass ribbon 78, the inner tube 22 can be rotated until the slot 34 in the inner tube 22 aligns with the discharge passage 58 formed in the discharge arm 14. This rotation can be done manually or mechanically such as under computer control. The material 94 falls out of discharge passage 58 of the discharge arm 14 by the force of gravity and the induced vibration of the vibration device 68. Alternatively, a carrier gas can be pumped through the discharge arm 14 into the storage chamber 30 to push the material 94 out of the discharge passage 58 at a greater rate and/or with a greater velocity. The rate of discharge can be controlled by increasing or decreasing the size of the opening by rotating the inner tube 22 and/or increasing the vibration frequency of the vibration device 68 and/or increasing the flow rate of the carrier gas.

The material 94 exiting the discharge arm 14 is deposited on top of the float glass ribbon 78, i.e., on the surface opposite to the surface supported on the molten metal 76. The material 94 is incorporated into or interacts with the float glass ribbon 78 to form a textured or irregular surface which scatters or deflects light rays. For example, the material 94 can react, e.g., chemically react, with the upper surface of the float glass ribbon 78, such as by covalent or ionic bonding with the silicon oxide network or glass network oxygen or network formers of the float glass ribbon 78 to chemically alter the upper surface of the float glass ribbon 78. Additionally or alternatively, the material 94 can be physically incorporated into or entrapped in the upper surface of the float glass ribbon 78. Moreover, the material can be fused with, e.g., adhered to, the glass ribbon 78.

As will be appreciated, the material 94 can be deposited over the entire top surface of the float glass ribbon 78 by one or more applicators 12. For example, one applicator 12 can cover or extend over a portion of the float glass ribbon 78 and another applicator 12 can cover or extend over the remainder of the float glass ribbon 78. Alternatively, the material 94 need not be deposited over the entire top surface of the float ribbon 78. For example, the material 94 can be deposited in the middle portion of the ribbon 78, i.e., spaced from the edges of the float ribbon 78, by one or more applicators 12 to prevent or minimize material 94 dropping into the molten metal 76. Moreover, one or more applicators 12 can be used to form patterns or designs on selected areas on the float glass ribbon 78. These patterns can be of any desired shape or size, such as but not limited to parallel stripes, contours, checkerboard patterns, etc. Additionally, the different applicators 12 can be used to deposit different materials 94, e.g., materials of different colors or of different particle sizes, to form areas of varying color or texture, i.e., areas of different colors or varying degrees of light scattering, on the ribbon 78. Alternatively, two or more applicators 12 can be used to sequentially deposit two or more different materials, e.g., differently colored materials, one on top of the other on the surface of the glass ribbon 78 to form differently colored layers that have the combined effect of changing the perceived or transmitted color of the resultant glass.

The material 94 deposited onto the top surface of the float glass ribbon 78 can form a non-repeating pattern (i.e., the pattern is not limited to the repeating pattern of an embossed roller) which scatters electromagnetic radiation, such as electromagnetic energy in the visible region of the electromagnetic spectrum. Alternatively, a repeating pattern could be formed, e.g., by starting and stopping the discharge of material 94 from the applicator 12. As the material 94 is incorporated into the float glass ribbon 78, some of the atmosphere of the float chamber 11 may become entrapped in the surface of the float glass ribbon 78 forming entrained gas bubbles. These gas bubbles can also increase the light scattering or deflecting characteristics of the resultant article.

Additionally, if the material 94 is deposited before or during the time when the ribbon 78 is being sized, e.g., elongated or stretched due to the lehr force pulling the ribbon 78 toward the end of the float chamber 11 or the attenuators exerting force on the sides of the ribbon, the aspect ratio (length/width) of the pattern formed by the deposited material can change. For example, even if the deposited particulate material is substantially spherical, the longitudinal stretching of the glass ribbon 78 caused by the lehr force can tend to elongate the pattern formed by the deposited material in the longitudinal direction of the ribbon 78.

Thus, in the practice of the invention, the light scattering surface can be formed on the float glass ribbon 78 in the float chamber 11 without the need for additional processing steps outside of the float chamber 11. In other words, the glass exits the float chamber 11 in its substantially final morphology, i.e., substantially final surface texture. The material 94 is incorporated (e.g., by chemical bonding, or physical entrapment, or fusion (adhesion)) into the glass in the float chamber 11. For example, the material 94 can be deposited onto the ribbon 78 at or above the glass transition temperature of the ribbon 78. By “glass transition temperature” is meant the temperature at which a super-cooled glass solidifies without devitrifying. Above the glass transition temperature the glass is a liquid and below the glass transition temperature the glass is a solid. Alternatively, the material 94 can be deposited onto the ribbon 78 at or above the glass transition temperature of the material 94 but not necessarily above the glass transition temperature of the ribbon 78. Still further, the material 94 can be deposited at a temperature below the glass transition temperature of the material 94 and/or the ribbon 78 but at a temperature above the chemical reaction (bonding) temperature of the material 94 with the ribbon 78. Moreover, the material 94 can be deposited at a temperature above the softening point of the ribbon 78.

When the float glass ribbon 78 with the material 94 incorporated in its upper surface exits the float chamber 11, the ribbon 78 can be controllably cooled, e.g., annealed, tempered, or otherwise heat treated, in any conventional manner and cut to form a glass article. Due to the addition of the material 94 onto the top surface of the glass ribbon 78 in the float chamber 11, the upper surface of the article will have light scattering or deflecting properties. The extent of these light deflecting properties can be adjusted by varying the deposition parameters of the material 94, e.g., the composition of the material 94, the mass coverage, the ribbon speed, the location in the float chamber 11 where the material 94 is deposited (i.e., time and temperature), etc.

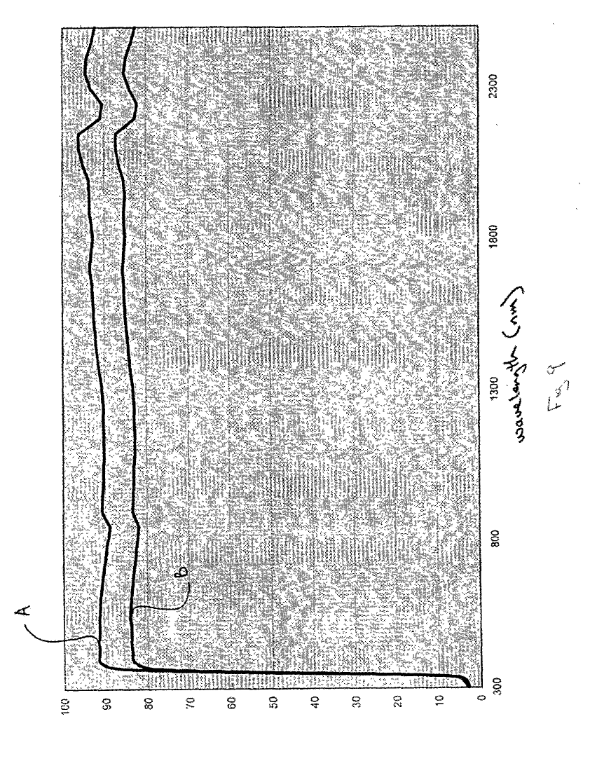

An exemplary glass article 100 formed in accordance with the invention is shown in FIG. 7. The article 100 can have any desired thickness and has a first surface 102 spaced from a second surface 104 (the second surface 104 being the surface in contact with the molten metal 76 in the float chamber 11). The first surface 102 has a light deflecting or light scattering patterned and/or textured portion formed over at least a portion thereof in accordance with the teachings of the invention, e.g., as described above by the deposition of the material 94 onto the float glass ribbon 78 in the float chamber 11. In one embodiment, the patterned and/or textured portion of the first surface 102 can have a root mean square (RMS) surface roughness of 50 nanometers (nm) or more, e.g., 100 nm or more, e.g., 400 nm to 800 nm. RMS surface roughness can be an average value determined by atomic force microscopy by measurement of the root mean square roughness over a surface area of one square micrometer, as is known in the art. As an additional example, the first surface can have an RMS surface roughness on the order of 1 or more micrometers. Additionally, in one embodiment, the pattern amplitude of the irregular first surface can be in the range of 50 nm to 3 micrometers, e.g., 100 nm to 2 micrometers. By “pattern amplitude” is meant the difference between the initial surface of the substrate and the outermost point or peak of an irregularity formed on that surface. For example, FIG. 8 depicts an enlarged side view of a portion of the glass article 100 of FIG. 7. An imaginary dashed line 150 represents the level of the upper surface of the substrate without the presence of the added material 94. The pattern amplitude for one irregularity 152 (e.g., peak) can be defined as the distance 154 between the theoretical surface of the substrate without the material (represented by dashed line 150) and the outermost point 156 of the irregularity 152. Alternatively, the pattern amplitude can be defined as the average distance between the peaks and valleys of the irregularities formed on the surface. The pattern amplitude can be equal to, less than, or greater than the size of the applied particles.

Depending on the material 94, as the roughness of the first surface 102 increases, the surface can become more abrasive. Therefore, the amount of material 94 added should be sufficient to provide a desired amount of light scattering (a desired amount of obscurity) but not so much that the surface becomes unacceptably abrasive for a desired use. For example, the article 100 formed in accordance with the invention can be used for, but not limited to, shower stall doors or panels, lighting fixtures, workplace or office dividers, privacy windows such as for basements, bathrooms, etc., solar panel covers, architectural and residential windows, non-vision automotive transparencies, panes for insulating glass units, and the like where the light scattering surface is preferably not abrasive. Alternatively, the article 100 could be used for other applications, such as for security glass panels, where increased abrasiveness would be desirable.

The second surface 104, i.e., the surface that is in contact with the molten metal 76 during the float process, can be much smoother than would be possible with the previous embossed roller techniques. For example, the second surface 104 can have a RMS surface roughness of less than or equal to 5 nm, e.g., less than or equal to 2 nm, e.g., less than or equal to 1 nm, e.g., less than or equal to 0.5 nm. In one embodiment, the second surface 104 can have a RMS surface roughness in the range of 0.2 nm to 2 nm. This smoothness promotes easier cleaning, e.g., wiping, of the second surface 104. Additionally, the second surface 104 can have metal, e.g., tin or tin oxide, diffused therein from contact with the molten metal in the float chamber 11. This tin oxide can enhance the durability of the second surface 104 against chemical attack and/or mechanical wear and can increase its index of refraction.

As shown in FIG. 7, an optional functional coating 110 can be deposited over at least a portion of the article 100, e.g., over all or a portion of side 102 and/or side 104. The coating on side 102 can be the same as or different than the coating on side 104. As used herein, the term “functional coating” refers to a coating which modifies one or more physical properties of the substrate on which it is deposited, e.g., optical, thermal, chemical or mechanical properties, and is not intended to be removed from the substrate during subsequent processing. The functional coating 110 may have one or more functional coating films of the same or different composition or functionality. The functional coating 110 can include interference layers of electromagnetic energy absorbing and non-absorbing inorganic compounds to provide color or aesthetics, solar control properties, or catalytic properties. The perceived and/or transmitted color of the coated article can be affected by varying the thickness of the coating 110.

For example, the functional coating 110 can be a photocatalytic coating or a hydrophilic coating, such as titanium dioxide. The titanium dioxide can be of sufficient thickness to provide the article 100 with a hydrophilic surface, e.g., 5 Å to 1000 Å. Examples of photocatalytic and/or hydrophilic coatings are disclosed in WO 00/75087 and in U.S. Pat. Nos. 6,027,766; 6,054,227; 5,873,203; 6,103,363; and 6,013,372, herein incorporated by reference. Alternatively, the functional coating 110 can be an electrically conductive coating, such as, for example, an electrically conductive heated window coating as disclosed in U.S. Pat. Nos. 5,653,903 and 5,028,759, or a single-film or multi-film coating capable of functioning as an antenna. Likewise, the functional coating 46 can be a solar control coating, for example, a visible, infrared or ultraviolet energy reflecting or absorbing coating. Examples of suitable solar control coatings are found, for example, in U.S. Pat. Nos. 4,898,789; 5,821,001; 4,716,086; 4,610,771; 4,902,580; 4,716,086; 4,806,220; 4,898,790; 4,834,857; 4,948,677; 5,059,295; and 5,028,759, and also in U.S. patent application Ser. No. 09/058,440. Similarly, the functional coating 110 can be a low emissivity coating. “Low emissivity coatings” allow visible wavelength energy, e.g., 395 nm to 800 nm, to be transmitted through the coating but reflect longer-wavelength solar infrared energy and/or thermal infrared energy and are typically intended to improve the thermal insulating properties of architectural glazings. By “low emissivity” is meant emissivity less than or equal to 0.4, such as less than or equal to 0.3, e.g., less than or equal to 0.2. Examples of low emissivity coatings are found, for example, in U.S. Pat. Nos. 4,952,423 and 4,504,109 and British reference GB 2,302,102. The functional coating 110 can be a single layer or multiple layer coating and can comprise one or more metals, non-metals, semi-metals, semiconductors, and/or alloys, compounds, composites, combinations, or blends thereof. For example, the functional coating 110 can be a single layer metal oxide coating, a multiple layer metal oxide coating, a non-metal oxide coating, or a multiple layer coating. The coating 110 can have one or more functional properties, such as one or more of the properties discussed above.

Non-limiting examples of suitable functional coatings for use with the invention are commercially available from PPG Industries, Inc. of Pittsburgh, Pa. sold under the trademarks SUNGATE® and SOLARBAN®. Such functional coatings typically include one or more anti-reflective coating films comprising dielectric or anti-reflective materials, such as metal oxides or oxides of metal alloys, which are transparent or substantially transparent to visible light. The functional coating 110 can also include infrared reflective films comprising a reflective metal, e.g., a noble metal such as gold, copper or silver, or combinations or alloys thereof, and can further comprise a primer film or barrier film, such as titanium, as is known in the art, located over and/or under the metal reflective layer.

The functional coating 110 can be deposited over a portion or all of one or both of the first and/or second surfaces 102,104 in any conventional manner, such as but not limited to physical vapor deposition (PVD), such as magnetron sputter vapor deposition (MSVD), thermal or electron-beam evaporation, cathodic arc deposition, and plasma spray deposition, or chemical vapor deposition (CVD), spray pyrolysis (i.e., pyrolytic deposition), atmospheric pressure CVD (APCVD), low-pressure CVD (LPCVD), plasma-enhanced CVD (PEVCD), and plasma assisted CVD (PACVD), or wet chemical deposition (e.g., sol-gel, mirror silvering etc.). For example, U.S. Pat. Nos. 4,584,206 and 4,900,110, herein incorporated by reference, disclose methods and apparatus for depositing a metal containing film on the bottom surface of a float glass ribbon by chemical vapor deposition. Such a known apparatus can be located downstream of the float chamber 11 in the float glass process to provide a functional coating on the underside of the float glass ribbon, i.e., the side opposite the light scattering surface of the invention. If desired, one or more other CVD coaters can be located in the float chamber 11 to deposit a functional coating over the light scattering surface so that either or both surfaces 102, 104 can have a coating.

Thus, the present invention provides a method and apparatus for forming patterned and/or textured glass articles that can be easily and cost effectively incorporated into a conventional flat glass process, such as a float process. The float process for a particular type of glass can be practiced as normal but, when patterned and/or textured glass is desired to be formed, the apparatus and/or method of the invention can be practiced without adversely impacting the ongoing float process. The patterned glass can be formed in the float chamber without the need for a separate embossing line. Further, by manipulating the applicator or selecting appropriate particulate shapes and/or quantities, a variety of obscuration patterns can be provided on the glass without the need to change embossing rolls. For example, the obscuration pattern can be changed by laterally shifting the applicator 12 or by using a gas stream to deflect the material 94 falling from applicator 12 to broaden or narrow the area onto which the material 94 is applied. Additionally, different degrees of obscurity can be provided by the same device and/or method by adjusting the position of the device in the float chamber 11 and/or the mass coverage of the material deposited onto the float glass ribbon. Additional factors which can affect the obscurity and/or appearance, e.g., color, of the glass article include the line speed of the ribbon and the composition and morphology of the material added.

Illustrating the invention are the following examples which are not to be considered as limiting the invention to their details. Unless otherwise indicated, all parts and percentages in the following examples, as well as throughout the specification, are by weight.

### EXAMPLE 1

The following example illustrates the production of glass in accordance with the invention in a conventional float process.

An applicator as shown in FIGS. 1-4 was constructed and was used to apply crushed glass material onto a float glass ribbon supported on a bath of molten tin in a conventional float chamber. Crushed glass material of different sizes was deposited on the float glass ribbon at different locations in the float chamber and at different deposition parameters as described below. Unexpectedly, the area of material deposition on the ribbon was very well defined and the downward flow of material was not noticeably affected by the atmosphere in the float chamber.

The float glass ribbon was 4.8 mm thick (final thickness) and had a composition to yield solar control glass commercially available from PPG Industries, Inc. of Pittsburgh, Pa. under the trademark SOLARGREEN®. The applicator was inserted at different positions (i.e., different bays) in the float chamber and was positioned about 3 inches to 4 inches (7.5 cm to 10 cm) above the top surface of the ribbon during application of the material. The applicator had a 2 ft. (61 cm) long discharge slot.

The material deposited onto the top of the float ribbon was prepared by crushing 2 mm to 6 mm thick clear (i.e., non-colored) float glass to form particles (frit) of different sizes. In the following discussion, the size range of the deposited particles is reported by a two number designation followed by a particle size range in millimeters. For example, a particle size of “−16+30” means that the particles passed through a 16 mesh screen (i.e., a screen having 256 uniformly sized openings per square inch) but were retained by a 30 mesh screen (a screen having 900 uniformly sized openings per square inch). Subsequent analysis indicates that a small amount of finer material may also have been present.

The reported temperatures of the float ribbon and the molten tin at the tested positions in the float chamber were obtained using a Raynger II infra-red gun (Model R2G5) commercially available from the Raytek Corporation of Santa Cruz, Calif.

A number of trials were conducted to apply the crushed glass material onto the float ribbon at different positions in the float chamber and under different deposition parameters. Table 1 below lists the deposition parameters for 17 trials. A designation of N/A means that the particular reading was not taken.

TABLE 1

| | | | | Wt. of | | Ribbon | | Mass |
|---|---|---|---|---|---|---|---|---|
| | Glass | Tin | | Frit | Discharge | Speed | Flow | Coverage |
| Trial | Temp. | Temp | Frit Size | Applied | Time | in/min | lbs/sec | lbs/ft² |
| No. | ° F. (° C.) | ° F. (° C.) | (mm) | lbs. (Kg) | (sec) | (cm/min) | (Kg/sec) | (Kg/m²) |
| 1 | 1471 | 1508 | −16 + 30 | 1.65 | 60 | 180 | 0.028 | 0.055 |
| | (799) | (819) | (0.6-1.2) | (0.7) | | (457) | (0.013) | (0.27) |
| 2 | 1471 | 1508 | −30 + 50 | 3.05 | 56 | 180 | 0.054 | 0.109 |
| | (799) | (819) | (0.3-0.6) | (1.4) | | (457) | (0.024) | (0.53) |
| 3 | 1471 | 1508 | −50 + 70 | 3.3 | 60 | 180 | 0.055 | 0.110 |
| | (799) | (819) | (0.21-0.3) | (1.5) | | (457) | (0.025) | (0.54) |
| 4 | 1600 | 1594 | −8 + 16 | 5.5 | 60 | 152 | 0.092 | 0.217 |
| | (870) | (867) | (1.2-2.4) | (2.5) | | (386) | (0.04) | (1.06) |
| 5 | 1600 | 1594 | −16 + 30 | 10 | N/A | 152 | N/A | N/A |
| | (870) | (867) | (0.6-1.2) | (4.5) | | (386) | | |
| 6 | 1600 | 1594 | −16 + 30 | 9.25 | 60 | 152 | 0.154 | 0.365 |
| | (870) | (867) | (0.6-1.2) | (4.2) | | (386) | (0.07) | (1.8) |
| 7 | 1600 | 1594 | −30 + 50 | 5.35 | 60 | 152 | 0.089 | 0.211 |
| | (870) | (867) | (0.3-0.6) | (2.4) | | (386) | (0.04) | (1.0) |
| 8 | 1600 | 1594 | −50 + 70 | 4 | 60 | 152 | 0.067 | 0.158 |
| | (870) | (867) | (0.21-0.3) | (1.8) | | (386) | (0.03) | (0.8) |
| 9 | 1586 | 1594 | −8 + 16 | 4.15 | 60 | 133 | 0.069 | 0.187 |
| | (862) | (867) | (1.2-2.4) | (1.9) | | (338) | (0.03) | (0.9) |
| 10 | 1586 | 1700 | −16 + 30 | 7.75 | 60 | 133 | 0.129 | 0.350 |
| | (862) | (926) | (0.6-1.2) | (3.5) | | (338) | (0.06) | (1.7) |
| 11 | N/A | 1626 | −8 + 16 | 6.2 | 60 | 142 | 0.103 | 0.262 |
| | | (885) | (1.2-2.4) | (2.8) | | (361) | (0.05) | (1.3) |
| 12 | N/A | 1626 | −16 + 30 | 9.45 | 60 | 142 | 0.158 | 0.399 |
| | | (885) | (0.6-1.2) | (4.3) | | (361) | (0.07) | (2.0) |
| 13 | N/A | 1626 | −16 + 30 | 6.2 | 60 | 142 | 0.103 | 0.262 |
| | | (885) | (0.6-1.2) | (2.8) | | (361) | (0.05) | (1.3) |
| 14 | N/A | 1553 | −16 + 30 | 6.85 | 60 | 170 | 0.114 | 0.242 |
| | | (844) | (0.6-1.2) | (3.1) | | (432) | (0.05) | (1.2) |
| 15 | N/A | 1553 | −30 + 50 | 3.9 | 60 | 170 | 0.065 | 0.138 |
| | | (844) | (0.3-0.6) | (1.8) | | (432) | (0.03) | (0.7) |
| 16 | N/A | 1553 | −50 + 70 | 5.25 | 60 | 170 | 0.088 | 0.185 |
| | | (844) | (0.21-0.3) | (2.4) | | (432) | (0.04) | (0.9) |
| 17 | N/A | 1626 | −16 + 30 | 18 | 124 | 142 | 0.145 | 0.368 |
| | | (885) | (0.6-1.2) | (8.1) | | (361) | (0.07) | (1.8) |

Upon exiting the float chamber, the float glass ribbon with the incorporated material moved through a conventional in-line annealing lehr. After annealing, the glass ribbon was cut into sheets and then into 10 cm by 10 cm sample coupons for testing and evaluation. An unexpected consequence of the invention was the smoothing or rounding of the sharp edges of the particulate material applied onto the float glass ribbon. It had been expected that due to the high ribbon speed and the relatively short residence time in the float chamber, a significant level of sharp edges and corners would remain on the surface of the glass article. However, the light scattering surface of the coupons was found to be relatively devoid of sharp edges or projections. This would be particularly useful for use in such articles as shower doors or glass office partitions where abrasive surfaces are not desired. However, by adjusting the deposition parameters as described above, the light scattering surface can be made more abrasive for uses such as security glass.

The coupons were tested for obscuration in the following manner. By “obscuration” is meant how indistinct or blurred an object appears when viewed through the glass coupon. Targets were made using two sets of six high contrast line pairs with one set oriented perpendicular to the other set. A line pair includes a black line and a white line (or white space) of equal dimensions on a white background. The dimensions of the line pairs were varied to obtain targets with 7, 6, 5, 4, 3, 2, 1.5, 1, and 0.75 lines cm⁻¹ (the targets used were obtained from Remote Sensing Principles and Interpretation (2^{nd} Ed.), by Sabins, Floyd F., W H Freeman & Co. 1987, herein incorporated by reference). The targets were placed behind the glass coupon being treated and parallel to the glass surface. The targets were moved away from the glass until the individual line pairs of a particular target could no longer be visually distinguished when viewed through the glass coupon. The distance from the glass coupon to the target when the line pairs could no longer be distinguished (the “obscuration value”) was measured and recorded for both the airside (light scattering side) and the tin side (smooth side) of the glass coupon facing the observer. The measurements were repeated three times for each side of the glass coupon and for each target. The average obscuration values for the three measurements are reported in Table 2 for looking through the light scattering side and in Table 3 for looking through the smooth side. The obscuration values listed in Tables 2 and 3 are in units of inches (centimeters).

The “Trial No.” listed in Tables 2 and 3 correspond to the glass made according to the same Trial No. in Table 1 above. For Trial No. 1 reported in Tables 2 and 3, the target had a maximum range of motion of 48 inches (122 cm). Therefore, a result of “>48” means that the target had been moved away from the glass coupon the maximum amount and the line pairs were still distinguishable. For Trials 2-17, the maximum range of motion of the target was 12 inches (30 cm).

TABLE 2
(Light Scattering Side facing observer)

| Trial | Line Pairs Per Centimeter | | | | | | | | |
|---|---|---|---|---|---|---|---|---|---|
| No. | 7 | 6 | 5 | 4 | 3 | 2 | 1.5 | 1 | 0.75 |
| 1 | 48 | >48 | >48 | >48 | >48 | >48 | >48 | >48 | >48 |
| | (122) | (>122) | (>122) | (>122) | (>122) | (>122) | (>122) | (>122) | (>122) |
| 2 | 2⅓ | 1 17/24 | 3⅜ | 6 7/12 | 9 35/48 | >12 | >12 | >12 | >12 |
| | (5.9) | (4.3) | (8.6) | (16.8) | (24.7) | (>30) | (>30) | (>30) | (>30) |
| 3 | 5/24 | ¼ | ½ | ½ | ⅚ | 1 9/16 | 1 43/48 | 3 5/48 | 4½ |
| | (0.5) | (0.6) | (1.3) | (1.3) | (2.1) | (4) | (4.8) | (2.8) | (11.4) |
| 4 | 9/16 | 1 5/12 | 1 7/48 | 1½ | 1⅞ | 2 11/12 | 3 5/12 | 5¼ | 5⅚ |
| | (1.4) | (3.6) | (2.9) | (3.8) | (4.8) | (7.4) | (8.7) | (13.3) | (14.8) |
| 5 | <⅛ | <⅛ | ¼ | ¼ | ½ | ½ | 29/48 | 35/48 | 1 |
| | (<0.3) | (<0.3) | (0.6) | (0.6) | (1.3) | (1.3) | (1.5) | (1.9) | (2.5) |
| 6 | ⅙ | ⅛ | ¼ | 17/48 | 25/48 | 9/16 | 11/12 | 1¼ | 1 19/24 |
| | (0.4) | (0.3) | (0.6) | (0.9) | (1.3) | (1.4) | (2.3) | (3.2) | (4.6) |
| 7 | 1 1/24 | 1 1/48 | 1 37/48 | 2⅓ | 2½ | 3½ | 5 1/24 | 7 | 9½ |
| | (2.6) | (2.6) | (4.5) | (5.9) | (6.4) | (8.9) | (12.8) | (17.8) | (24) |
| 8 | 3 19/24 | 3⅝ | 6¼ | 8½ | 8½ | 9 43/48 | >12 | >12 | >12 |
| | (9.6) | (9.2) | (15.9) | (21.6) | (21.6) | (25.1) | (>30) | (>30) | (>30) |
| 9 | 5⅝ | 6 1/48 | 6 19/24 | 8¾ | 8¾ | 9½ | 11⅝ | >12 | >12 |
| | (14.3) | (15.3) | (17.3) | (22.2) | (22.2) | (24) | (29.5) | (>30) | (>30) |
| 10 | 7 11/24 | 9 7/12 | 12 | >12 | >12 | >12 | >12 | >12 | >12 |
| | (18.9) | (24.3) | (30) | (>30) | (>30) | (>30) | (>30) | (>30) | (>30) |
| 11 | ⅜ | 7/12 | 1 | 1 11/24 | 1¼ | 2 | 2½ | 3¾ | 4¼ |
| | (0.95) | (1.5) | (2.5) | (3.7) | (3.2) | (5.1) | (6.35) | (9.5) | (10.8) |
| 12 | N/A | N/A | N/A | N/A | N/A | N/A | N/A | N/A | N/A |
| 13 | 1⅛ | 1⅓ | 2 1/12 | 2⅞ | 2⅞ | 3 37/48 | 4½ | 5⅜ | 6¾ |
| | (2.9) | (3.4) | (5.3) | (7.3) | (7.3) | (9.6) | (11.4) | (13.7) | (17.1) |
| 14 | ⅜ | ⅜ | 19/24 | 1¼ | 2 | 3¼ | 4 | 6¼ | 9¾ |
| | (0.95) | (0.95) | (2.0) | (3.2) | (5.1) | (8.3) | (10.2) | (15.9) | (24.8) |
| 15 | 1 1/24 | 1⅚ | 3⅙ | 3½ | 4 1/12 | 5 5/12 | 6⅚ | 8 | 10¾ |
| | (3.7) | (4.7) | (8.0) | (8.9) | (10.4) | (13.8) | (17.4) | (20.3) | (27.3) |
| 16 | ⅛ | ⅛ | ½ | 5/16 | ¾ | 1 | 1⅜ | 2 | 2⅚ |
| | (0.3) | (0.3) | (1.3) | (0.8) | (0.6) | (2.5) | (3.5) | (5) | (7.2) |
| 17 | 1 1/16 | 23/24 | 1 | 1 23/24 | 2¼ | 2⅔ | 3 5/12 | 4½ | 5⅚ |
| | (2.7) | (2.4) | (2.5) | (5.0) | (5.7) | (6.8) | (8.7) | (11.4) | (14.8) |

As can be appreciated from Table 2, comparing Trial No. 2 with Trial No. 3 in which the material was deposited at the same location in the float chamber and at about the same mass coverage, it appears that as the particle size decreased the resultant glass became more obscure (i.e., the obscurity of the glass increases). Comparing Trial Nos. 13 and 17, as the mass coverage increases while the other parameters remain substantially the same, the obscurity of the glass tends to increase. Comparing Trial Nos. 10 (closer to the entrance end) and 14 (farther from the entrance end), as the material is deposited farther from the entrance end of the float chamber, while the other parameters remain substantially the same, the obscurity of the glass tends to increase. Comparing Trial Nos. 3 and 8, as the deposition temperature of the glass ribbon increases, the mass coverage (amount of material per unit area) can be increased to maintain a similar degree of obscurity.

TABLE 3
(Smooth Side facing observer)

| Trial | Line Pairs Per Centimeter | | | | | | | | |
|---|---|---|---|---|---|---|---|---|---|
| No. | 7 | 6 | 5 | 4 | 3 | 2 | 1.5 | 1 | 0.75 |
| 1 | N/A | N/A | N/A | N/A | N/A | N/A | N/A | N/A | N/A |
| 2 | 2 | 2¾ | 2 15/16 | 3 | 3¼ | 4⅞ | 6¼ | 7⅛ | 12 |
| | (5) | (7.0) | (7.5) | (7.6) | (8.3) | (12.4) | (15.9) | (18.1) | (30) |
| 3 | 5/16 | ⅝ | ¾ | 1 15/16 | 1½ | 1⅝ | 2⅜ | 3⅜ | 4 |
| | (0.8) | (1.6) | (1.9) | (4.9) | (3.8) | (4.1) | (6.0) | (8.6) | (10) |
| 4 | 1 | 1⅛ | 1¼ | 1¾ | 2⅛ | 2½ | 3¼ | 3¾ | 5⅞ |
| | (2.5) | (2.9) | (3.2) | (4.4) | (5.4) | (6.4) | (8.3) | (9.5) | (14.9) |
| 5 | ¼ | ½ | 9/16 | ⅝ | ⅝ | ⅝ | ⅞ | ⅞ | 1½ |
| | (0.6) | (1.3) | (1.4) | (1.6) | (1.6) | (1.6) | (2.2) | (2.2) | (3.8) |
| 6 | ⅜ | 7/16 | ½ | ⅝ | 11/16 | ⅞ | 1⅛ | 1⅝ | 2¼ |
| | (0.95) | (1.1) | (1.3) | (1.6) | (1.7) | (2.2) | (2.9) | (4.1) | (5.7) |
| 7 | 1¼ | 1½ | 1¾ | 2½ | 2¾ | 3⅜ | 4⅜ | 6½ | 8 3/16 |
| | (3.2) | (3.8) | (4.4) | (6.4) | (7.0) | (8.6) | (11.1) | (16.5) | (20.8) |
| 8 | 4 13/16 | 5¾ | 6¼ | 8¾ | 9¾ | >12 | >12 | >12 | >12 |
| | (12.2) | (14.6) | (15.9) | (22.2) | (24.8) | (>30) | (>30) | (>30) | (>30) |
| 9 | 5 | 6⅞ | 8⅜ | 9¾ | 10¾ | >12 | >12 | >12 | >12 |
| | (12.7) | (17.5) | (22.2) | (24.8) | (27.3) | (>30) | (>30) | (>30) | (>30) |
| 10 | 8½ | 9⅞ | 11½ | >12 | >12 | >12 | >12 | >12 | >12 |
| | (21.6) | (25) | (29.2) | (>30) | (>30) | (>30) | (>30) | (>30) | (>30) |
| 11 | 1½ | 2¼ | 2⅞ | 3¼ | 3¾ | 4⅜ | 5 1/16 | 5⅝ | 7⅛ |
| | (3.8) | (5.7) | (7.3) | (8.3) | (9.5) | (11.1) | (12.9) | (14.3) | (18.1) |
| 12 | N/A | N/A | N/A | N/A | N/A | N/A | N/A | N/A | N/A |
| 13 | 1 3/16 | 1 9/16 | 1 15/16 | 2⅛ | 2 5/16 | 3 | 4⅛ | 5 | 7⅜ |
| | (3.0) | (4.0) | (4.9) | (5.4) | (5.9) | (7.6) | (10.5) | (12.7) | (18.7) |
| 14 | ⅜ | ⅞ | 1 | 1⅛ | 1 7/16 | 2¼ | 3 | 4 | 5¼ |
| | (0.95) | (2.2) | (2.5) | (2.9) | (3.7) | (5.7) | (7.6) | (10) | (13.3) |
| 15 | ½ | ⅝ | ⅞ | 1 | 1⅛ | 1½ | 1¾ | 3¼ | 4½ |
| | (1.3) | (1.6) | (2.2) | (2.5) | (2.9) | (3.8) | (4.4) | (8.3) | (11.4) |
| 16 | ⅝ | ¾ | ⅞ | 1⅛ | 1½ | 2 | 5⅝ | 3½ | 4½ |
| | (1.6) | (1.9) | (2.2) | (2.9) | (3.8) | (5.1) | (6.7) | (8.9) | (11.4) |
| 17 | 1 5/16 | 1⅝ | 2 1/16 | 2⅛ | 2⅝ | 2¾ | 3½ | 4⅞ | 6 9/16 |
| | (3.3) | (4.1) | (5.2) | (5.4) | (6.7) | (7.0) | (8.9) | (12.4) | (16.7) |

The same generalities discussed above also seem to apply when looking through the tin side of the glass (see Table 3).

The roughness of the bottom (tin side) of a glass coupon from Trial No. 13 was measured using a Tencor P1 Profilometer commercially available from the Tencor Corporation of San Jose, Calif. The settings for the profilometer were as listed in Table 4.

TABLE 4

| Length | 100 | μm |
|---|---|---|
| Speed | 100 | μm/sec. |
| Time | 10 | sec. |
| Horiz. Res. | 2 | μm |
| Sty. Force | 15 | mg |
| Sty. Drop | 3 | |
| Sty. Radius | 12.5 | μm |
| V. Range | 13 | μm/ |
| | 520 | μin |
| Direction | --> | |
| Repeats | 1 | |
| Lw. Cutoff | 80 | μm |

| | |
|---|---|
| Sw. Cutoff | Default |

Table 5 lists the results of the profilometer measurement.

TABLE 5

| | | |
|---|---|---|
| Ra (average roughness) | 3.9 | Å |
| Max Ra (maximum roughness) | 5.5 | Å |
| Rq (root mean square roughness) | 4.8 | Å |
| Wa (wavyness) | 25.4 | Å |
| Wq (wavyness) | 31.4 | Å |
| TIR (total indicator run-out, | 840.7 | Å |
| i.e., distance between highest | | |
| and lowest points) | | |
| Profl (distance profile taken) | 999.7339 | μm |

From Table 5, it can be appreciated by one skilled in the art that the bottom (tin) side of the measured coupon is much smoother than for conventional patterned glass formed by the prior embossed roller method. Such prior articles typically had a bottom side roughness on the order of hundreds of A and waviness on the order of several thousand A.

### EXAMPLE 2

This example illustrates transmittance characteristics for a glass article formed in accordance with the invention.

In this example, crushed glass material was applied onto a float glass ribbon in similar manner as described above. The float glass ribbon was 3.3 mm thick (final thickness) and had a composition to yield SOLARPHIRE® to clear transition glass commercially available from PPG Industries, Inc. of Pittsburgh, Pa. The material added was crushed STARPHIRE® glass commercially available from PPG Industries, Inc. of Pittsburgh, Pa. and the deposition parameters are shown in Table 6 below. The temperature of the glass was not specifically measured but should be approximately the same as the tin temperature at the deposition position.

TABLE 6

| | | | Wt. of | | Ribbon | | Mass |
|---|---|---|---|---|---|---|---|
| | | | Frit | Discharge | Speed | Flow | Coverage |
| Trial | Tin Temp | Frit Size | Applied | Time | in/min | lbs/sec | lbs/ft² |
| No. | ° F. (° C.) | (mm) | lbs. (Kg) | (sec) | (cm/min) | (Kg/sec) | (Kg/m²) |
| 18 | 1587 | −16 + 30 | 9.45 | 60 | 139 | 0.158 | 0.489 |
| | (862) | (0.6-1.2) | (4.3) | | (353) | (0.07) | (2.38) |
| 19 | 1591 | −16 + 30 | 7.1 | 60 | 176 | 0.118 | 0.290 |
| | (866) | (0.6-1.2) | (3.4) | | (447) | (0.05) | (1.4) |

After annealing, the ribbon was cut into 2 inch by 2 inch (5 cm by 5 cm) coupons and evaluated for transmittance at 550 nm using a Lambda 9 spectrophotometer commercially available from the Perkin-Elmer Company of Wellesley, Mass. For each coupon, a total of nine measurements were taken at spaced intervals over the coupon to determine an average transmittance for the coupon. The results of these measurements are shown in Table 7 below.

TABLE 7

| | Avg. % Transmittance | Avg. % Transmittance |
|---|---|---|
| Trial | (Smooth Side) | (Patterned Side) |
| 18 | 88.4 | 90.5 |
| 19 | 86.4 | 90.9 |

By “Patterned Side” is meant that the patterned side of the coupon was facing the light source and by “Smooth Side” is meant the smooth (i.e., non-patterned) side of the coupon was facing the light source. Surprisingly, it was determined that transmittance at 550 nm through the coupons differed depending upon whether the light source was facing the smooth side (lower transmittance) or the patterned side (higher transmittance), i.e., the percent transmittance between the first surface (patterned surface) and the second surface (smooth surface) is different.

FIG. 9 shows a graph of percent transmittance versus wavelength for a coupon of Trial 18. As can be seen, this difference in transmittance between the Smooth Side (curve B) and the Patterned Side (curve A) appears over a wide range of wavelengths.

It will be readily appreciated by those skilled in the art that modifications may be made to the invention without departing from the concepts disclosed in the foregoing description and example. Accordingly, the particular exemplary embodiments described in detail herein are illustrative only and are not limiting to the scope of the invention, which is to be given the full breadth of the appended claims and any and all equivalents thereof.

We claim:

1. A method of forming glass in a float glass process, comprising:
applying a material comprising particles onto at least a portion of a float glass ribbon while in a float chamber to incorporate at least a portion of the material into the ribbon to form a light scattering surface on the float glass ribbon.

2. The method of claim 1, wherein the material comprises solid particles.

3. The method of claim 2, wherein the material comprises glass particles having a size in the range of about 26 micrometers to about 8 mm.

4. The method of claim 1, wherein the material has a thermal expansion coefficient substantially the same as the thermal expansion coefficient of the float glass ribbon.

5. The method of claim 1, wherein the material is applied at a mass coverage sufficient to provide the light scattering surface with a root mean square surface roughness greater than or equal to about 50 nm.

6. The method of claim 1, wherein the material includes at least one colorant.

7. The method of claim 6, wherein the colorant is selected from elements or compounds of titanium, selenium, cobalt, cerium, vanadium, molybdenum, chromium, nickel, manganese or copper.

8. The method of claim 1, wherein the float glass ribbon is soda-lime-silica glass.

9. The method of claim 1, wherein the float glass ribbon has a temperature in the range of 1100° F. to 2200° F. (592° C. to 0.1203° C.).

10. The method of claim 1, including heat treating the glass ribbon with the incorporated material.

11. The method of claim 1, wherein the float glass ribbon has a top surface and a bottom surface, wherein the bottom surface is in contact with a pool of molten tin, wherein the material comprises crushed glass particles, and wherein the method includes depositing the crushed glass particles onto at least a portion of the float glass ribbon top surface in the float chamber to form the light scattering surface.

12. The method of claim 1, including applying the glass particles to form a non-repeating pattern.

13. The method of claim 1, including applying the material closer to an entrance end of the float chamber than an exit end of the float chamber to decrease the obscurity of the glass.

14. The method of claim 1, including increasing the mass coverage of the material on the ribbon to increase the obscurity of the glass or decreasing the mass coverage of the material on the. ribbon to decrease the obscurity of the glass.

15. The method of claim 1, including incorporating the material by at least one of chemical bonding, adhesion, or physical entrapment.

16. The method of claim 1, wherein the material comprises two or more different types of particles.

17. The method of claim 1, wherein the material comprises at least one material selected from crushed glass, metal, and metal oxide.

18. The method of claim 17, wherein the metal oxide is selected from oxides of titanium or chromium.

19. The method of claim 16, wherein the material comprises soda-lime-silica glass particles and borosilicate glass particles.

20. The method of claim 1, including deforming the ribbon to change an aspect ratio of a pattern formed by the applied solid particles.

21. The method of claim 1, including providing a functional coating over at least a portion of the glass.

22. The method of claim 21, including providing a functional coating over at least a portion of the light scattering surface or a surface of the glass opposite to the light scattering surface.

23. The method of claim 22, wherein the functional coating is selected from a solar control coating, a low emissivity coating, a photocatalytic coating, and a hydrophilic coating.

24. A method of forming a glass article, comprising:
applying glass particles onto a float glass ribbon in a float chamber at a temperature above the glass transition temperature of the ribbon such that at least a portion of the glass particles are incorporated into the ribbon to form a light scattering surface on the ribbon in the float chamber.

25. The method of claim 24, including annealing or tempering the ribbon with the light scattering surface formed thereon.

26. The method of claim 24, including chemically bonding the glass particles with the glass network oxygen or network formers of the ribbon.

27. The method of claim 24, including physically entrapping the glass particles in the ribbon.

28. A method of obscuring a substrate, comprising:
applying a material comprising particles onto at least a portion of a substrate having a temperature in the range of 1100° F. to 2200° F. (592° C. to 1203° C.) to incorporate at least a portion of the material into the substrate.

29. An apparatus, comprising:
an applicator including an outer member having at least one charging opening and at least one discharge opening, with the discharge opening spaced from the charging opening, and
an inner member movably carried in the outer member and having at least one opening.

30. The apparatus of claim 29, wherein the applicator comprises a discharge arm mounted on a movable carrier.

31. The apparatus of claim 29, wherein the applicator is extensible into and out of a float chamber above a molten metal pool.

32. The apparatus of claim 29, wherein the applicator is permanently mounted in a float chamber above a molten metal pool.

33. The apparatus of claim 29, when the inner member is a tube including at least one storage chamber and the inner member is another tube rotatable between a first position in which the inner tube opening is aligned with the charging opening and a second position in which the inner tube opening is aligned with the discharge opening.

34. A glass article, comprising:
a first surface having a light scattering surface portion; and
a second surface spaced from the first surface,
wherein the light scattering portion is formed by depositing a material comprising particles onto a float glass ribbon in a float chamber to incorporate at least a portion of the material into the ribbon to form the light scattering surface.

35. The article of claim 34, wherein the first surface has a different composition than the second surface.

36. The article of claim 34 wherein the first surface comprises entrapped gas bubbles.

37. The article of claim 34, wherein the first surface has a root mean square surface roughness of greater than or equal to 50 nm.

38. The article of claim 34, wherein the second surface has a root mean square surface roughness of less than or equal to 0.1 micrometer.

39. The article of claim 34, wherein the second surface has a root mean square surface roughness of less than or equal to 5 nm.

40. The article of claim 34, wherein the second surface includes diffused metal.

41. The article of claim 40, wherein the second surface includes diffused tin.

42. The article of claim 41, wherein the first surface has a thermal expansion coefficient substantially the same as the thermal expansion coefficient of the second surface.

43. The article of claim 34, including a functional coating deposited over at least a portion of the article.

44. The article of claim 43, wherein the functional coating includes titanium dioxide.

45. The article of claim 43, wherein the functional coating is deposited by a process selected from MSVD, PVD, CVD, spray pyrolysis, and sol-gel.

46. The article of claim 43, wherein the functional coating is a solar control coating.

47. The article of claim 43, wherein the functional coating is deposited over at least a portion of the first surface.

48. The article of claim 43, wherein the functional coating is deposited over at least a portion of the second surface.

49. A glass article, comprising:
a first surface having a light scattering surface portion; and
a second surface spaced from the first surface,
wherein the light scattering portion is formed by depositing a material comprising glass particles onto a soda-lime-silica float glass ribbon in a float chamber to incorporate at least a portion of the material into the ribbon to form the light scattering surface, wherein the first surface has a RMS surface roughness greater than or equal to 50 nm, and wherein the second surface has diffused tin and a RMS surface roughness of less than or equal to 5 nm.

50. A glass article, comprising:
a first surface having a light scattering surface; and
a second surface spaced from the first surface, wherein a percent transmittance of visible light through the article is different when illuminating the first surface and the second surface.

51. A glass article formed by the method of claim 1.

52. An article, comprising:
a first surface having a light scattering portion; and
a second surface spaced from the first surface,
wherein the light scattering portion is formed by depositing a material comprising particles onto a substrate to incorporate at least a portion of the material into the substrate to form the light scattering surface.

53. The article of claim 52, wherein the light scattering surface forms a non-repeating pattern.

54. The article of claim 52 wherein the first surface comprises entrapped gas bubbles.
